(19) United States
(12) Patent Application Publication
(10) Pub. No.: US 2006/0187297 A1
(43) Pub. Date: Aug. 24, 2006

(54) HOLOGRAPHIC 3-D TELEVISION

(76) Inventor: Levent Onural, Ankara (TR)

Correspondence Address: LEVENT ONURAL, BILKENT UNIVERSITY HOUSES 10/1, ANKARA, TR-06533, TR

(21) Appl. No.: 11/160,437

(22) Filed: Jun. 23, 2005

Related U.S. Application Data
(60) Provisional application No. 60/655,835, filed on Feb. 24, 2005.

(51) Int. Cl. H04N 13/00; H04N 5/89

(52) U.S. Cl. 348/40

(57) ABSTRACT

A three-dimensional television system captures the 3-D motion scene, represents the captured scene using 3-D computer graphics methods, transmits this data, converts this abstract 3-D scene into holographic signals by computationally efficient algorithms, and then, displays these signals holographically to yield true three-dimensional motion pictures.

### CROSS-REFERENCE TO RELATED APPLICATION

The present application claims the benefit of provisional patent application No. 60/655,835, entitled Holographic 3-D Television, filed Feb. 24, 2005, the contents of which are expressly incorporated herein by reference.

### FIELD OF THE INVENTION

The present invention relates to television systems which captures, processes, transmits and holographically displays true three-dimensional motion pictures.

### BACKGROUND OF THE INVENTION

The present invention is a television system which produces true three-dimensional motion pictures based on holographic techniques at the display end. The integrated system comprises four major functional units: 1—3-D scene capture unit 2—storage or transmission of the captured 3-D scene to the display end (“transmission unit”), 3—a holographic display unit, 4—a computation unit for computing holographic fringe patterns and/or display driver signals.

A 3DTV system, with all its integral functional units as classified above is a complex system. And therefore, each such identified unit can be implemented using a vast variety of different techniques. Both the individual techniques adopted for each such unit, as well as the specific relationship among those units, and therefore, a specific collection of choices are naturally subjects of inventions.

There are different techniques for the visualization of three-dimensional motion pictures. An early technique is stereoscopy which is essentially based on the principle of providing two slightly different pictures to left and right eyes of the observer, where these two pictures are taken from the scene at a slightly different angle to match the actual difference in the viewing angle when an observer, with two eyes, looks at the scene. There are various techniques for channeling the two different images to the corresponding eyes: some common ones use different colors, different light polarization, shutters to sequentially turn the right and left image on and off, etc. Using optics, like cylindrical lenticular lenses (vertical strips of lenses) or micro-lens arrays to effectively separate the right and left views are also common. Furthermore, there are many commonly known techniques to capture these two images (for example, by using two regular video cameras), and then to store or transmit to the receiver which then displays these images to match the employed right-left separation technique. Such techniques are commonly known as stereoscopic 3DTV. Some examples in the literature are, U.S. Pat. Nos. 4,734,756, 4,740,836, 4,907,860, 5,537,144, 5,541,642, 5,594,843, 5,661,518, 5,742,330, 5,745,164, 5,821,989, 6,593,959, 6,603,442, 6,603,876, 6,759,998, and papers by Kajiki et al. (Y. Kajiki, H. Yoshikawa, and T. Honda, Autostereoscopic 3-D Video Display Using Multiple Light Beams with Scanning, IEEE T. on CSVT, 10(2), pp. 254-260, March 2000), Yan et al, (J. Yan, S. T. Kowel, H. J. Cho, C. H. Ahn, G. P. Nordin and J. H. Kulick, Autostereoscopic Three-dimensional Display Based on Micromirror Array, Applied Optics, 43(18), pp. 3686-3696, June 2004). Being a holographic 3DTV, the present invention is different compared to stereoscopic techniques mentioned here in this paragraph.

Stereoscopic 3DTV systems have been improved to provide multiple views, so that as the viewer moves in front of the display, his/her right and left eyes receives the appropriate images that would have been seen from the location that the viewer moves to. Such systems may simultaneously display such multiple images to corresponding directions, like the ones which employ micro-lens arrays; some systems detect the position of the observer's head, and adaptively choose the pair of stereo images to match the observer's detected position. Some provide variation only along the horizontal direction, whereas better ones can accommodate both horizontal and vertical parallax. Some examples in the literature are, U.S. Pat. Nos. 5,710,875, 5,717,453, 5,745,126, 5,771,121, 5,850,352, 5,886,675, 5,986,811, 6,593,957, 6,757,422 6,795,241, 6,816,158. Being based on holographic display techniques, the present invention is fundamentally different from the 3DTV systems mentioned in this paragraph.

Holography is another 3-D viewing technique which is based on the reproduction of light, ideally with its all physical properties, in the absence of the objects which generated the original light distribution in 3-D space. Therefore, holographic 3DTV is based on capturing and reproduction of light in 3-D space associated with a moving 3-D scenery. Examples of holographic 3DTV in the literature are U.S. Pat. Nos. 3,541,238, 3,544,711, 3,566,021, 3,888,561, 4,376,950, 4,408,277, 5,172,251, 5,347,375, 5,515,183, 6,130,957, 6,219,435, 6,269,170, and papers by Enloe et al. (L. H. Enloe, J. A. Murphy, and C. B. Rubenstein, Hologram Transmission via Television, Bell Syst. Tech. J. 45(2), pp. 225-339, 1966.), Hashimoto et al, (N. Hashimoto, S. Morokawa, Real-time Electroholographic System Using Liquid Crystal Television Spatial Light Modulators, J. of Electronic Imaging 2(2), pp. 93-99, 1993), Onural et al. (L. Onural, G. Bozda\check{g}i, A. Atalar, New High-resolution Display Device for Holographic Three-dimensional Video: Principles and Simulations, Optical Engineering, 33(3), pp. 835-844, March 1994). The present invention is also a holographic 3DTV system. However, the present invention is different than other holographic 3DTV systems as described later in this document.

One of the embodiments of the present invention is based on the efficient computation of the diffraction patterns which are used by the holographic display unit. Fast and efficient computation of such patterns from given 3-D objects is critical, and therefore, fast algorithms are needed. Several proposed methods are found in the literature. D. Leseberg and C. Frere, Computer Generated Hologram of 3-D Objects Composed of Tilted Planar Segments, Applied Optics 27, 3020-24, 1988, and T. Tommasi and B. Bianco, Computer-generated Holograms of Tilted Planes by a Spatial Frequency Approach, JOSA A, 10(2), 299-305, 1993 are two examples. N. Delen and B. Hooker, Free-space Beam Propagation Between Arbitrarily Oriented Planes Based on Full Diffraction Theory: A Fast Fourier Transform Approach, JOSA A, 15, 857 (1998) and U.S. Pat. No. 5,982,954 present an approach for computation of diffraction field on tilted planes. K. Matsushima, H. Schimmel and F. Wyrowski, JOSA A, 20(9), 1755-1762, 2003, presents a similar method, and examine several interpolation algorithms to show the effect of the interpolation algorithms on the computed diffraction pattern.

### SUMMARY OF THE INVENTION

The main contribution of the present invention is an end-to-end holographic 3DTV system which is more advanced, flexible, and therefore more useful, compared to the systems found in the literature. A main distinction compared to the prior art is the elimination of capturing or recording holographic signals at the input; instead the compound input unit captures the 3-D scene using various techniques including abstract representation of the captured 3-D scene by computer graphics methods. Compression techniques convenient for 3-D scene data are employed for the transmission of the captured data to a display unit. The display unit is holographic. Therefore, efficient algorithms are used to obtain the needed holographic signals and/or signals to drive holographic display units which would then give the true 3-D replica of the scene.

### DETAILS OF THE INVENTION

The present invention is a television system which produces true three-dimensional motion pictures. The integrated system comprises four major functional units: 1—3-D scene capture unit 2—storage or transmission of the captured 3-D scene to the display end (“transmission unit”), 3—a holographic display unit, 4—a computation unit for computing holographic fringe patterns and/or display driver signals.

One of the distinguishing features of the present invention compared to holographic 3DTV prior art is its 3-D scene capture unit: even though the technology adopted for the display is holographic, the capture unit is not based on capturing the hologram itself or any fringe patterns. Rather, it is a unit which captures the three-dimensional structure and texture of the scene. There are alternative methods of capturing 3-D scenes, in the literature, where each one of these methods could be more suitable to the properties of the scene being shot. The subject matter of present invention is not the specific technology used to capture the 3-D motion scene. Instead, the invention is focused on the coupling of a non-holographic scene capture with a holographic display. Methods of capturing 3-D motion scene are known to those skilled in the field. For example, a simple possibility is a single ordinary video camera: consecutive frames obtained from the camera, as the objects and/or camera changes its position from one frame to another can be used, together with an associated computational algorithm, to compute the three dimensional scene as the input. The specifics of the algorithm depend on the details of the physical camera structure and some rather common properties of the objects in the scene like their rigidity/deformability, etc. Another possibility is to use two video cameras (stereo) or even more cameras. For example, a compound camera may be formed as a collection of many (typically 4-8, depending on the desired scene complexity, 3-D accuracy and resolution) cameras, forming an array, where each element of the array (camera) is directed to the scene at an angle, all recording simultaneously. Camera angles, and the relative positions of the cameras may be fixed or variable in time. The elements of this array maybe positioned to view the scene at rather closer angles; it is also possible to mount the cameras to locations which practically surround the scene from completely different viewing angles. Naturally, as the number of cameras increase, it will be easier to capture the 3-D scene information more accurately, but the calibration and coordination of cameras become more difficult. The physical distances between the cameras could be small for rather smaller scenes or maybe quite large for larger scenes. Motion of cameras could be allowed for some applications. If it is possible to mount position markers (devices which detect and transmit their relative or absolute locations using wired or wireless connections) over the surfaces in the scene (including moving objects), the collection of these devices, or a combination of such devices and optical cameras may also be used to form the input unit. Optical cameras maybe replaced by sensors which use other techniques to detect objects. Knowing the structure and other properties of the physical input unit (some possibilities are described above), and using image processing and computer graphics techniques, one can generate a 3-D description of the scene computationally and store it (permanently or temporarily) in digital form. For example, the 3-D structure can be computationally formed by detecting feature points of the objects in the scene, and then by matching these points in slightly different images of the scene as captured by each camera by computation; knowing the relative coordinates of the cameras, and their orientation, one can form a wire-frame mesh structure. Such wire-frame structures, which are lists of 3-D coordinates of nodes and edges which link the nodes, are commonly used in computer graphics practice. A wire-mesh model gives a 3-D object whose surface consists of planar patches that are usually triangular in shape. Furthermore, color and brightness variations over the wire-mesh modeled object surface (the texture) are also naturally captured by the video cameras. Using the constructed wire-frame data, the captured texture, and the motion, one can generate images of 3-D scenes; using existing technology, such artificial and natural (or hybrid) 3-D images are commonly displayed on 2-D TV or computer monitors. Rarely, they are also displayed using stereoscopic techniques to generate 3-D displays with limited features common to stereoscopy. A distinguishing feature of the present invention is the presence of the abstract computer-graphics-based intermediate stage within the 3-D motion scene capture unit, where this representation is then converted by computation to holographic signals needed by the display unit.

Transmission of captured video data has been a common practice for decades as in television broadcasting. While the practice had started with direct transmission of raster scanned frames, digital techniques later brought significant improvement in efficiency and quality: nowadays, it is a common practice to transmit digital video in compressed form. More sophisticated techniques are emerging every day. The actual information theoretic content of a regular 3-D scene is not too complicated to justify transmission of huge number of bits to duplicate the scene at a remote location. Using 3-D video compression techniques, one can achieve an efficient means of transmission using significantly less number of bits compared to direct transmission of raster scanned digitized video frames. Specifically, it is possible to compress the overall video data coming from an array of multiple cameras, as indicated in the above paragraph, in an efficient manner, and the resultant bit-stream complexity will not be too large compared to a simple video from a single camera. This is a result of the fact that each video camera shoots the same scene at a slightly different angle, and therefore, captures essentially the same data with little variation; therefore, there is a high redundancy in captured data, and this results in large compression ratios without significant loss. Another efficient compression technique for 3DTV is the compression of moving mesh structures. As a conclusion, transmission, or storage, of the captured 3-D video data is efficient when digital video compression techniques are adapted. Very efficient compression is possible if the structures of 3-D objects, their relative positions, and their relative motion can be separately described and then the scene is reconstructed from this information at the receiving end. Actual physical transmission of the compressed signal can be in any form (cable, terrestrial, satellite, fiber-optic or other). The focus of the present invention is not the actual form of the transmission technique; instead the present invention claims a 3DTV system where a captured 3-D motion scene (not the associated holographic signals) is stored/transmitted for subsequent computational conversion to holographic signals for holographic display.

Once the data is transmitted to the display end, either local or remote, there is no problem in computationally creating the 3-D scene, by reconstructing the wire-frame and wrapping the scene texture on it. However, converting this abstract 3-D structure, which is typically stored digitally in computer memory, into a realistic true 3-D holographic display requires very special techniques. Holographic display unit re-creates the light, with the same properties as the light distribution in the captured 3-D scene. There are various techniques to achieve this duplication of 3-D light distribution. For example, an incoming light may be diffracted by optical fringes on a surface. The geometry of the surface which carries the fringe pattern is not necessarily a rectangular planar structure as in conventional TV screens; furthermore, the viewing angle is not necessarily limited to a rather a narrow angle in front of a screen. Rather, the fringe pattern can be generated on surfaces with unusual geometries which would then yield more realistic and clear 3-D holographic reconstructions. A possibility is to have the display in the shape of a pool table, where the time-varying fringes are imposed on appropriate optical, or acousto-optical, panels which are mounted both on the bottom tray, and also on the interior face of the shallow side-walls. It is possible to add fringe surfaces as hanging units on top of the table, generating diffracted light radiating from top to bottom to improve the quality. There is a plurality of light sources, including coherent ones (lasers) and non-coherent sources, all with different colors. Depending on the physics of the device which carries the fringes (spatial light modulators or acousto-optic devices), and their geometry and relative mounting positions with respect to the location and orientation of the light sources, a computer which runs a specific algorithm converts the captured, transmitted 3-D scene data, to a time-varying fringe pattern. Then the pattern is delivered to the display devices using electronic circuits, and electro-optical and electro-acoustic converters. Timing circuitry, controls the flashing of lasers and other lights. This operation generates true three-dimensional display of the original 3-D scene in a ghost-like fashion, recreated by diffracted light. Another possibility in creating a duplicate of the original 3-D light distribution is the synthesis of that distribution, not necessarily by classical holographic fringes, but by individually steering and superposing a plurality of elementary 3-D light patterns generated by means of an array of controllable optic elements. An example is digital micro mirror devices. The steering of each individual element, and thus the overall array, requires the generation and application of associated electronic driver signals.

One of the severe drawbacks of the state-of-the art holographic 3-D display systems is the lack of efficient algorithms which convert a given 3-D object into the desired holographic fringe patterns. Similarly, the efficient computation of the driver signals is a problem. An efficient algorithm, which converts the given wire-mesh model, together with its node and texture information into the desired holographic fringe patterns over a planar holographic plane, is one of the primary contribution of this invention. The algorithm, which is implemented on a computer, is as follows:

i—Given a wire-mesh model of an object, together with its texture (FIGS. 5 and 6), decompose the object model into planes, where each plane coincides with a wire-mesh patch (FIG. 7). Each such plane extends beyond the dimensions of the co-planar patch, but the data is set to zero outside of the boundaries of the patch. Thus a tilted plane which has the same texture as the patch within the boundaries of the patch, but zero values outside is created. Such a plane would normally have a tilted orientation with respect to the hologram plane. ii—Compute the holographic fringes associated with each one of the tilted planes corresponding to each wire-mesh patch (FIG. 8). It is possible to efficiently compute the diffraction pattern, and the effects of the reference beam between tilted planes as described in the literature. For example, a plane-wave decomposition approach would give the desired result by taking the Discrete Fourier Transform (DFT) of the pattern over the tilted plane, performing a re-ordering and interpolation of the obtained frequency components as inferred from the tilt angles to get another DFT representation, multiplying this new DFT representation by a complex-valued function corresponding to the translation of the diffraction pattern plane, and finally taking the inverse DFT. iii—Superpose the holographic fringes found for each plane in step (b) to get the final hologram fringe pattern corresponding to the texture wrapped wire-mesh object model.

The algorithm described above finds the hologram corresponding to a still 3-D wire-mesh modeled object. For a motion (TV) operation, such still frames are repeated one after another at a speed higher than the human visual system threshold for continuous perception, as always been done in movies and in conventional TV.

An efficient variation of the algorithm is not to compute the hologram fringes corresponding to each planar patch at every consecutive still frame, but to use the redundancy associated with the non-deformed patches which simply move rigidly in 3-D space from one location to another between the still frames that constitute the motion picture operation. More specifically, since the frequency (plane wave) components (i.e., the DFT) of a non-deformable (rigid) patch depends only on its texture and the shape, there is no reason to compute it over and over again; it is sufficient to perform only the sub-sequent operations as briefly described in step (ii) of the above algorithm.

Another variant of the algorithm which improves the quality of the resultant 3-D display is obtained by not zero-padding the planes beyond the extent of the corresponding wire-mesh patch, but by padding with those values which are obtained by considering the higher-order diffraction effects associated with the plurality of optically interacting non-parallel planar textures.

For monochromatic textures, the algorithm outlined above is sufficient. However, for color textures, the steps (b) and (c) of the algorithm should be repeated for each color component.

It is possible to generate moving holographic reconstructions of 3-D synthetic (computer generated) scenes, instead of capturing a 3-D scene. In this case, simply the input scene capture unit is not used, instead, the scene is purely computed from scratch. The other major components are still the same. It is also possible to combine real 3-D scenes (as captured by the compound camera) and synthetic (generated by pure computation) to form holographic reconstructions of hybrid 3-D scenes.

The result at the display end is a true 3-D dimensional scaled-size replica of the original scene where the scene and the objects are formed by diffracted light and appears in front of the observers as ghost-like images. The observers do not need any instrument, like special goggles, etc., to see the scene; if they like, they can move around the ghost-like objects to see them at different angles. Indeed, the observers may actually move into the scene and be a part of it as long as they do not block the path of the light components diffracted by the fringes.

Both the display unit and the compound camera of the proposed holographic TV system can be used also as standalone units. The camera maybe used to capture 3-D scenery which would then be utilized in various different ways; similarly stored (either artificially generated or obtained from natural scenes) 3-D scenes maybe displayed on a standalone holographic display.

### BRIEF DESCRIPTION OF FIGURES

The basic system is depicted in FIG. 1.

FIG. 2 depicts a typical 3-D scene input arrangement; a compound camera (an array of video cameras) 1 captures the scene 2.

FIG. 3 shows another 3-D scene input configuration; cameras 1 surrounding the 3-D scene 2 captures it.

FIG. 4 depicts a typical display geometry. There are a number of lasers 1 which illuminate the diffracting fringe patterns 2 generated on the panels mounted on a hanging support 5 and on the base and inner walls of a pool-table shaped base support 6 to generate a ghost-like moving 3-D replica of the scene. A viewer 4 observes the action.

FIG. 5 shows a wire-mesh model

FIG. 6 shows the wire-mesh model with texture wrapped over the surface.

FIG. 7 shows the tilted plane decomposition of the object shown in FIG. 6.

FIG. 8 shows the relative geometry of the planar components shown in FIG. 7 and the hologram plane.

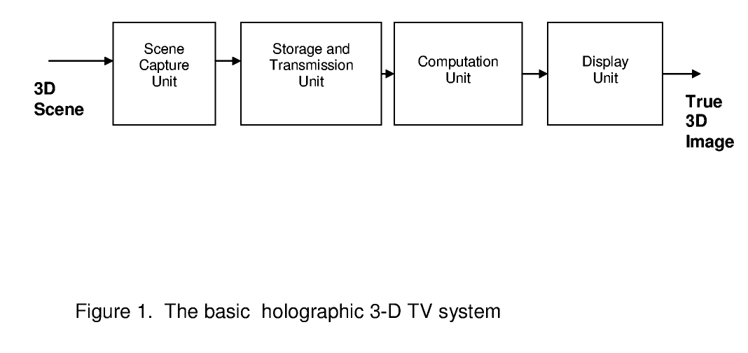

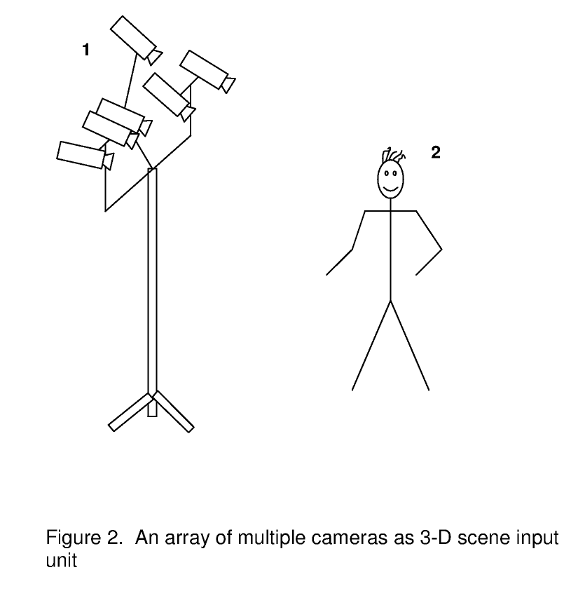

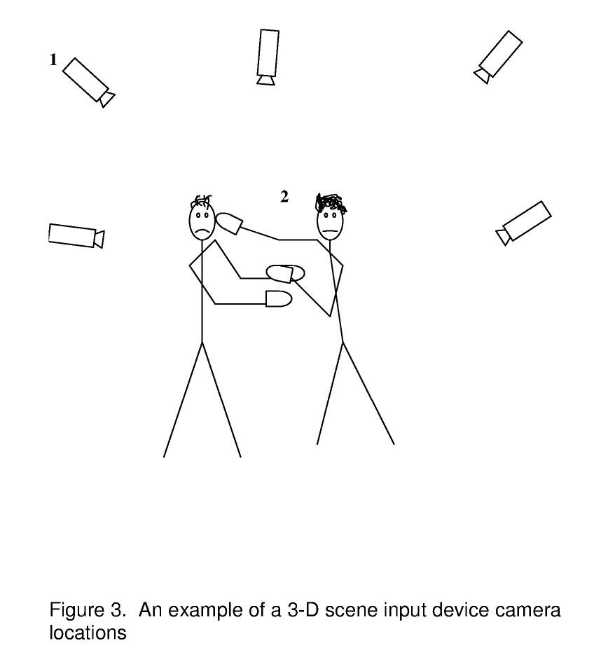

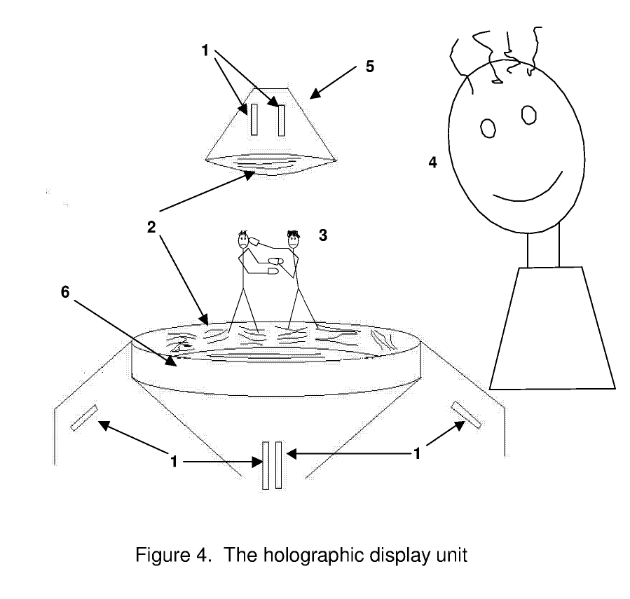

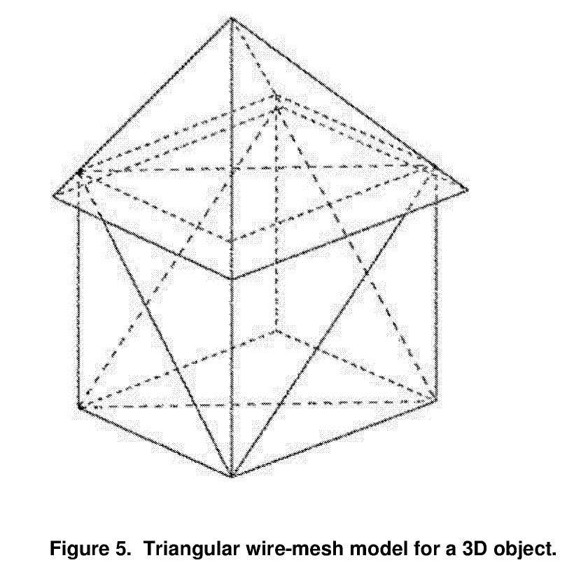

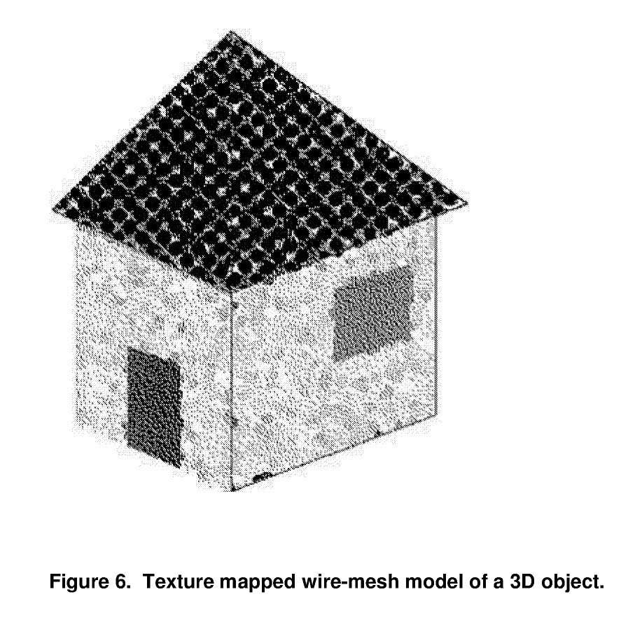

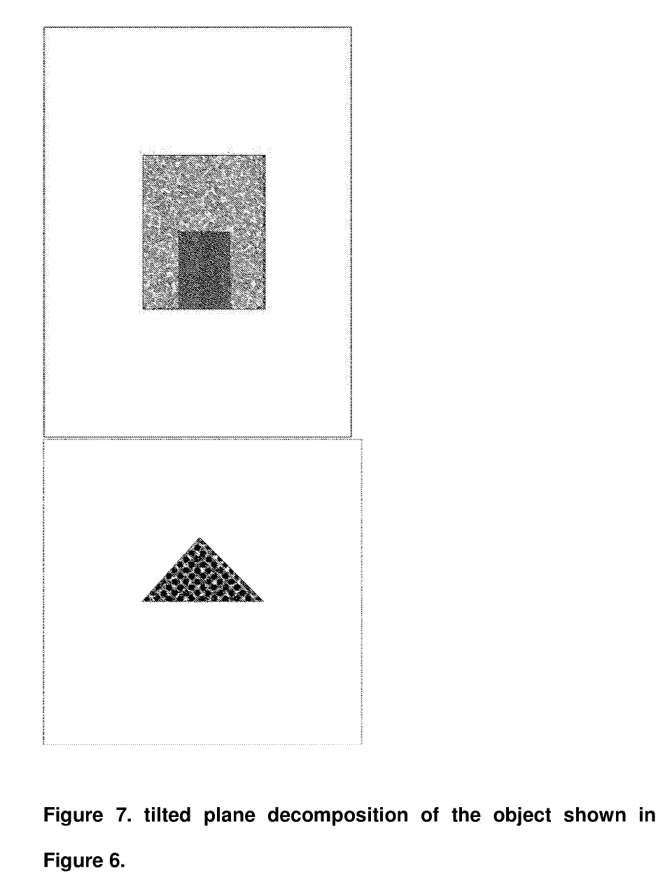

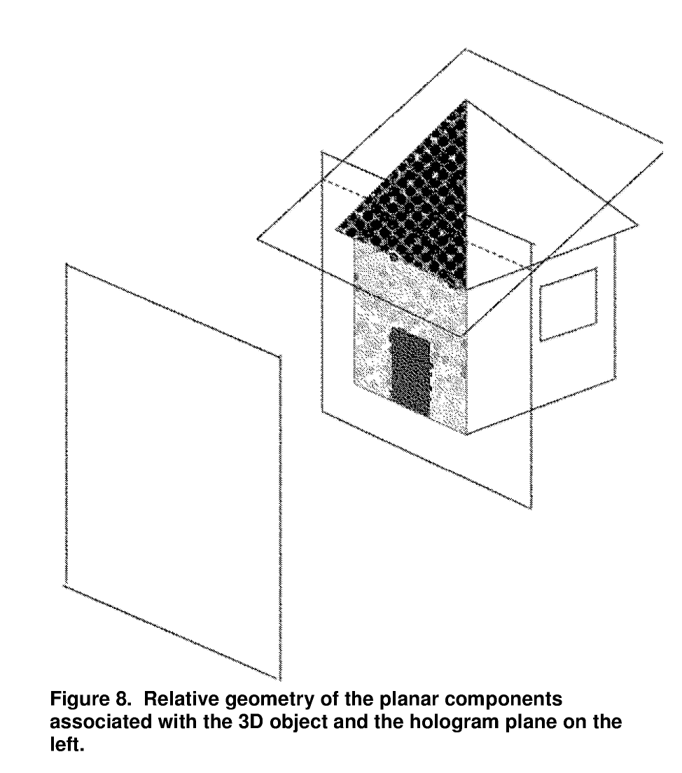

What is claimed is:

1. An apparatus for three-dimensional holographic television comprising,
a three-dimensional scene input unit,
a holographic three-dimensional motion picture display unit,
a means of transmission of the captured 3-D scene information from the input unit to the display unit,
a computational unit which converts captured three-dimensional scenes and objects into holographic fringe patterns and/or display unit driver signals.

2. The three-dimensional scene capture unit of claim 1, where the capture unit consists of a single video camera.

3. The three-dimensional scene capture unit of claim 1, where the capture unit consists of a plurality of video cameras.

4. The plurality of video cameras of claim 3, where the positions and the viewing angles of the cameras are fixed and stays stationary relative to each other.

5. The plurality of video cameras of claim 3, where the positions and the viewing angles of the cameras are variable relative to each other.

6. The three-dimensional capture unit of claim 1, where the capture unit consists of a number of three-dimensional position marker devices mounted on the objects and other locations in the scene.

7. The three-dimensional capture unit of claim 1, where the capture unit consists of a combination of video cameras and three-dimensional position markers.

8. The three-dimensional capture unit of claim 1, where the capture unit converts the received signals into a three-dimensional moving graphic representation.

9. The graphic representation of claim 8, where the representation is a wire-mesh structure.

10. The wire-mesh structure of claim 9, where the wire-mesh structure is covered by the texture (color and brightness variations over the surfaces) of the scene.

11. A computational unit of claim 1, where the computational unit implements an algorithm which decomposes the wire-mesh modeled object, or scene, into a plurality of planes where each plane coincides with the 3-D orientation of a planar element of the wire-mesh model, and for each such plane, computes the complex valued hologram fringe contribution of that plane onto the hologram plane, and then superposes the contributions of all such planes.

12. A computational unit as in claim 11 that computes the electronic signals, which drive the display unit, from the computed hologram fringe pattern.

13. The computational unit as in claim 11, where each plane after the decomposition has the same texture as the patch over its region that corresponds to the patch, but has a blank texture everywhere else.

14. The computational unit as in claim 11, where each plane after decomposition has the same texture as the patch over its region that corresponds to the patch, and the texture over the rest of the plane is not necessarily blank, but found according to principles of diffraction.

15. The computational unit as in claim 11, where the computations for each plane are repeated more than once for each plane, typically three times, if the wire-mesh texture is a color texture.

16. A computational unit as in claim 11, that stores the computed hologram fringe contributions of each wire-mesh patch, and then uses these coefficients also for the computation of hologram fringes associated with a later 3-D frame where the 3-D motion of the patch, as the object or scene moves between the two frames, is rigid.

17. The transmission unit of claim 1, where the transmission unit compresses the received signal from the capture unit.

18. The compression algorithm of claim 17, where the compression is performed by forming a description of the three-dimensional environment, objects, their structures, and their relative motion.

19. The compression algorithm of claim 18, where the description is achieved by listing the wire-mesh nodes and their motion.

20. The three-dimensional holographic display unit of claim 1, comprising one or more reflective or transmitting light diffraction elements, where these elements are mounted horizontally on a supporting base, or mounted vertically on the side-walls of a tray, with optional additional diffractive elements mounted on hanging support structures, or in any combination of these.

21. The diffractive elements of claim 20, where the diffractive elements consist of spatial light modulator arrays.

22. The diffractive elements of claim 20, where the diffractive elements consist of acousto-optic light diffracting arrays.

23. The diffractive elements of claim 20, where the diffractive elements consist of micro-mirror arrays.

24. The holographic TV apparatus of claim 1, where the operation consists of frame-by-frame capture, transmission and display of consecutive still frames, and the frame rate is higher than 20 frames per second.

25. The holographic TV apparatus of claim 1, where the operation consists of segmenting the input scene into separate 3-D objects and transmitting each object separately, computing holographic data associated with each object separately, and then overlaying such reproduced objects at the display side.

26. The holographic TV system of claim 1, where the main units have computational support.
